(19) United States
(12) Patent Application Publication
(10) Pub. No.: US 2022/0037648 A1
(43) Pub. Date: Feb. 3, 2022

(54) METAL BATTERY

(71) Applicant: Sumitomo Chemical Company Limited, Tokyo (JP)

(72) Inventors: Jack William Blincow, Blincow (GB); Thomas Johannes Kugler, Cambridge (GB); Evan Nicholas Keyzer, Godmanchester (GB)

(73) Assignee: Sumitomo Chemical Company Limited, Tokyo (JP)

(21) Appl. No.: 16/942,450

(22) Filed: Jul. 29, 2020

(51) Int. Cl. H01M 4/36; H01M 4/66; H01M 10/052; H01M 2/16

(52) U.S. Cl. CPC H01M 4/366; H01M 2/1673; H01M 10/052; H01M 4/661

(57) ABSTRACT

A metal battery (100) having a metal anode (103), e.g. a lithium metal battery, and an anode-free precursor thereof are disclosed. The metal battery or precursor contains an anode protection structure (105) containing a plasma-treated anode protection layer between an anode current collector (101) and a cathode (109). Plasma treatment may be He and or Ar plasma treatment. The plasma may further contain a fluorocarbon, e.g. CHF₃.

### BACKGROUND

Embodiments of the present disclosure relate to metal batteries, in particular lithium batteries, and methods of forming the same.

Lithium metal batteries are known. However, secondary (i.e. rechargeable) lithium metal batteries have found limited application due in part to the tendency of lithium dendrites to form at the lithium anode during charging of the battery. Dendrite formation may result in a short circuit, with associated risks of combustion or explosion of the battery. Consequently, secondary lithium ion batteries are used more widely than secondary lithium batteries in applications where recharging of the battery is required.

Kim et al, “Solventless thermal crosslinked polymer protective layer for high stable lithium metal batteries”, Sustainable Energy Fuels, 2020, 4, p 522-527, discloses a cross-linked poly(ethylene glycol) dimethacrylate (c-PEGDMA) film containing ethylene oxide units as a protective layer for the lithium metal surface of a lithium battery.

Choi et al, “Interfacial enhancement between lithium electrode and polymer electrolytes”, Journal of Power Sources, 2003, 119-121, p 610-616 discloses formation of a protection layer on the surface of lithium metal by ultraviolet radiation-curing of a mixture of crosslinking agent (1,6-hexanediol diacrylate), liquid electrolyte (ethylene carbonate (EC)/propylene carbonate (PC)/1 M LiClO₄), and photoinitiator (methyl benzoylformate).

EP2102924 discloses separation of electrolyte compositions within lithium batteries.

U.S. Pat. No. 9,954,213 discloses an electrochemical cell containing an electronically and ionically conductive layer.

EP 3413380 discloses a lithium secondary battery having a multilayer protective structure.

Wang et al, “Comparison between helium and argon plasma jets on improving the hydrophilic property of PMMA surface”, Applied Surface Science, 2016, 367, p 401-406 discloses hydrophilic modification effects of He and Ar plasma jets on PMMA.

### SUMMARY OF THE INVENTION

In some embodiment, the present disclosure provides a method of forming a metal battery or an anode-free precursor thereof comprising:
an anode current collector;
a cathode;
a cathode current collector in electrical contact with the cathode; and
an anode protection structure comprising an anode protection layer disposed between
the anode current collector and the cathode,
   wherein the anode protection layer comprises a polymer and formation of the anode protection layer comprises plasma treatment of anode protection layer precursor comprising the polymer.

Optionally, the method is a method of forming a metal battery; an anode is disposed between the anode current collector and the anode protection structure; the anode is in electrical contact with the anode current collector; and the anode is in direct contact with the anode protection structure.

Optionally, the method is a method of forming a metal battery precursor and the anode protection structure is in direct contact with the anode current collector.

Optionally, a separator is disposed between the anode protection structure and the cathode.

Optionally, the metal battery or anode-free precursor thereof further comprises a liquid electrolyte.

Optionally, the plasma comprises an inert gas.

Optionally, the plasma comprises at least one noble gas.

Optionally, the plasma comprises at least one of He and Ar.

Optionally, the plasma consists of one or more inert gases.

Optionally, the plasma further comprises a hydrofluorocarbon.

Optionally, the hydrofluorocarbon is CHF₃.

Optionally, the polymer is selected from PEO and PMMA.

Optionally, formation of the anode protection layer comprises formation and plasma treatment of the anode protection layer precursor on the anode current collector.

Optionally, formation of the anode protection layer comprises formation and plasma treatment of the anode protection layer precursor on a substrate.

Optionally, the anode protection layer is separated from the substrate and disposed over the anode current collector.

Optionally, the metal battery is a lithium battery.

Optionally, the anode protection structure consists of the anode protection layer.

Optionally, the metal battery is rechargeable.

In some embodiments, the present disclosure provides a metal battery or an anode-free precursor thereof comprising:
an anode current collector;
a cathode;
a cathode current collector in electrical contact with the cathode; and
an anode protection structure comprising an anode protection layer disposed between the anode current collector and the cathode,
   wherein the anode protection layer comprises a plasma-treated polymer.

### BRIEF DESCRIPTION OF THE DRAWINGS

FIG. 1 is a schematic representation of a cross-section of a metal battery having an anode protection layer consisting of a single material according to some embodiments;

FIG. 2 is a schematic representation of a method of forming a metal battery of FIG. 1;

FIG. 3 is a schematic representation of a cross-section of a metal battery having an anode protection layer containing two materials according to some embodiments;

FIG. 4A is a SEM image of a phase-separated layer formed from a blend of the polymers F8BT (9,9-dioctylfluorene-bentothiadiazole AB copolymer) and PMMA (polymethyl methacrylate);

FIG. 4B is an AFM phase contrast mode image of the phase separated layer of FIG. 4B;

FIG. 5A is a microscope image of an anode of a comparative battery formed using an anode protection layer of F8BT only; and

FIG. 5B is a microscope image of an anode of a battery according to some embodiments formed using a 50:50 F8BT:PMMA anode protection layer.

The drawings are not drawn to scale and have various viewpoints and perspectives. The drawings are some implementations and examples. Additionally, some components and/or operations may be separated into different blocks or combined into a single block for the purposes of discussion of some of the embodiments of the disclosed technology. Moreover, while the technology is amenable to various modifications and alternative forms, specific embodiments have been shown by way of example in the drawings and are described in detail below. The intention, however, is not to limit the technology to the particular implementations described. On the contrary, the technology is intended to cover all modifications, equivalents, and alternatives falling within the scope of the technology as defined by the appended claims.

### DETAILED DESCRIPTION

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” Additionally, the words “herein,” “above,” “below,” and words of similar import, when used in this application, refer to this application as a whole and not to any particular portions of this application. Where the context permits, words in the Detailed Description using the singular or plural number may also include the plural or singular number respectively. The word “or,” in reference to a list of two or more items, covers all of the following interpretations of the word: any of the items in the list, all of the items in the list, and any combination of the items in the list. References to a layer “over” another layer when used in this application means that the layers may be in direct contact or one or more intervening layers are may be present. References to a layer “on” another layer when used in this application means that the layers are in direct contact.

The teachings of the technology provided herein can be applied to other systems, not necessarily the system described below. The elements and acts of the various examples described below can be combined to provide further implementations of the technology. Some alternative implementations of the technology may include not only additional elements to those implementations noted below, but also may include fewer elements.

These and other changes can be made to the technology in light of the following detailed description. While the description describes certain examples of the technology, and describes the best mode contemplated, no matter how detailed the description appears, the technology can be practiced in many ways. As noted above, particular terminology used when describing certain features or aspects of the technology should not be taken to imply that the terminology is being redefined herein to be restricted to any specific characteristics, features, or aspects of the technology with which that terminology is associated. In general, the terms used in the following claims should not be construed to limit the technology to the specific examples disclosed in the specification, unless the Detailed Description section explicitly defines such terms. Accordingly, the actual scope of the technology encompasses not only the disclosed examples, but also all equivalent ways of practicing or implementing the technology under the claims.

To reduce the number of claims, certain aspects of the technology are presented below in certain claim forms, but the applicant contemplates the various aspects of the technology in any number of claim forms.

In the following description, for the purposes of explanation, numerous specific details are set forth in order to provide a thorough understanding of implementations of the disclosed technology. It will be apparent, however, to one skilled in the art that embodiments of the disclosed technology may be practiced without some of these specific details.

The present inventors have found that plasma treatment of a layer containing a polymer may reduce the extent to which the polymer swells and/or the extent to which the polymer dissolves in the presence of a solvent. The present inventors have identified that such plasma-treated polymer-containing layers may be used as an anode protection layer in a rechargeable metal battery.

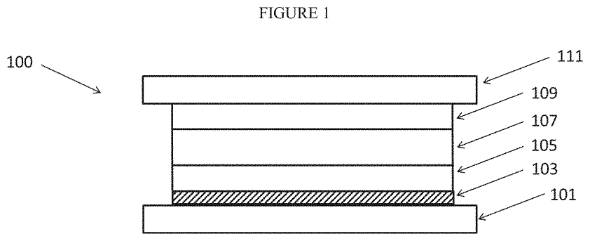

FIG. 1 illustrates a metal battery 100 according to some embodiments. The description hereinafter refers to lithium batteries having a lithium metal anode however it will be understood that other metals, e.g. sodium, may be used in place of lithium.

The lithium battery 100 has an anode current collector 101 in electrical contact with an anode 103 comprising a layer of lithium; a cathode current collector 111 in electrical contact with a cathode 109; a separator 107 disposed between the anode and cathode; and an anode protection structure disposed between the anode and the separator comprising an anode protection layer 105. Separator 107 is suitably in direct contact with the anode protection layer 105. Anode protection layer 105 is suitably in direct contact with anode 103.

In some embodiments, for example as illustrated in FIG. 1, the anode protection structure consists of the anode protection layer.

In some embodiments, the anode protection structure comprises two or more layers including the anode protection layer.

The anode and cathode current collectors may each be formed from any suitable conducting material, preferably a metal, e.g. copper or aluminium.

The anode protection layer comprises or consists of a first polymer which has been plasma treated. FIG. 1 illustrates a metal battery in which the anode protection layer consists of the first polymer. In other embodiments, the anode protection layer comprises or consists of two or more polymers, including the first polymer.

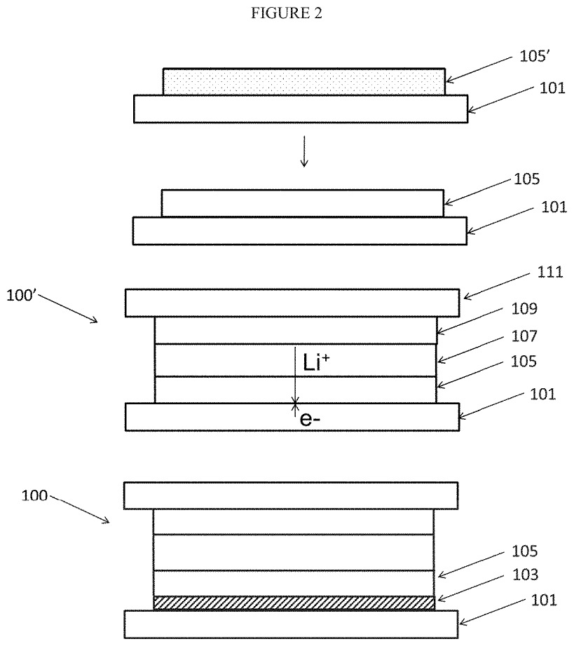

FIG. 2 illustrates a method of forming a lithium battery 100 according to some embodiments.

An anode protection precursor layer 105′ containing a first polymer is formed on an anode current collector 101. The anode protection precursor layer 105′ may be formed by any method known to the skilled person including, without limitation, deposition of the first polymer from a solution or dispersion and deposition of a monomer or monomers which are reacted to form the polymer. Following formation of the layer containing the first polymer, layer may be subjected to a curing treatment. The curing treatment may be at least one of irradiation, e.g. UV treatment, or heat treatment. Optionally, curing treatment is at a temperature in the range of about 50-170° C., optionally 50-120° C.

In some embodiments, the layer containing the first polymer undergoes crosslinking upon curing. A crosslinking group present in the layer may cause crosslinking. The crosslinkable group may be a group of a crosslinking agent mixed with the first polymer and/or a substituent of the first polymer. In a preferred embodiment, the layer containing the first polymer does not contain any crosslinkable groups.

The anode protection precursor layer 105′ is subjected to a plasma treatment to form anode protection layer 105. In some embodiments, the plasma includes or consists of at least one inert gas. Exemplary inert gases include noble gases, preferably He and Ar. In some embodiments, the plasma comprises one or more inert gases and a hydrofluorocarbon. An exemplary hydrofluorocarbon is CHF₃.

A metal battery precursor 100′ is completed by providing a cathode 109 supported on a cathode current collector 111 and a separator 107 between the anode protection layer 105 and cathode. Liquid electrolyte is provided in the structure and may be, e.g. absorbed in the separator and/or the anode protection structure.

The metal battery 100 may be formed by application of a bias across the anode current collector and the cathode current collector causing lithium ions to migrate through the anode protection layer, thus forming the anode 103 between the anode current collector 101 and the anode protection layer 105.

The plasma treated anode protection layer 105 may have reduced solubility and/or permeability in a liquid electrolyte of the metal battery as compared to a precursor layer 105′ before plasma treatment. The first polymer may undergo crosslinking upon plasma treatment.

Permeability of a polymer as described herein may be indicated by a percentage increase in mass of the material upon immersion of a film of the material in the electrolyte solvent for 30 minutes at 20° C. The solubility and percentage mass increase of a film of a polymer is measured as described in the examples of the present application.

FIG. 2 illustrates a process of formation of a metal battery from the metal battery precursor by plating of lithium upon a first charging. It will be understood that a process of re-plating of lithium during recharging of the battery, following discharge of the lithium battery and stripping of the lithium anode, may be essentially the same.

FIG. 2 illustrates a method in which anode protection layer 105 is formed on a current collector. In other embodiments, the anode protection layer 105 is formed on another substrate, e.g. glass or plastic, and then separated from the substrate for use as an anode protection layer. In these embodiments, the pre-formed anode protection layer may be deposited directly onto the current collector followed by formation of the lithium anode or the pre-formed anode protection layer may be deposited onto a lithium layer supported on a current collector.

FIGS. 1 and 2 illustrate metal batteries in which the anode protection layer consists of a single, plasma-treated first polymer. In other embodiments, the anode protection layer may contain the first polymer and one or more further materials.

In some embodiments, the anode protection layer contains first and second polymers. The anode protection layer may have a matrix and domains within the matrix wherein one of the matrix and domains contains or consists of a first polymer; and the other of the matrix and domains contains or consists of the second polymer.

Optionally, at least one of the first polymer and second polymer undergoes crosslinking upon exposure to the plasma.

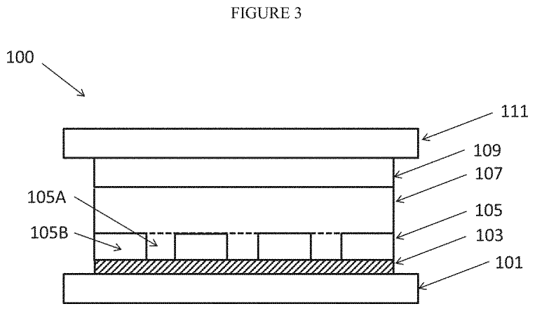

FIG. 3 illustrates a metal battery as described with respect to FIG. 1 except that the anode protection layer contains a matrix 105B comprising or consisting of a second polymer and domains, or islands, 105A comprising or consisting of a first polymer surrounded by the matrix. At least some of the domains, optionally all of the domains, extend through the thickness of the anode protection layer.

Optionally, the second polymer is less permeable by a liquid electrolyte of the metal battery than the first polymer. Optionally, there is little or no transport of metal ions through the matrix 105B of the anode protection layer.

Preferably, the mass increase of the first polymer is at least twice, optionally at least five times, that of the second polymer upon immersion of a film of the polymer in an electrolyte solvent for 30 minutes at 20° C.

Preferably, the second polymer makes up a majority of the mass of the matrix. Preferably, no more than 10 wt % of the matrix comprises the first polymer.

Preferably, the first polymer makes up a majority of the mass of the domains. Preferably, no more than 10 wt % of the domains comprise the second polymer.

In some embodiments, the domains 105B may be randomly distributed and/or may have differing sizes. In some embodiments, the domains are regularly spaced within the matrix and/or are of the same size.

The matrix may contain only one second polymer or it may contain two or more second polymers. The domains may contain only one first polymer or they may contain two or more first polymers. The or each second polymer is less permeable to the electrolyte than the, or each, first polymer.

Optionally, domains 105B have a diameter in the range of about 100 nm-20 microns. In the case where the domains of an anode protection layer have differing sizes, the diameter is a mean average diameter.

Optionally, the domains make up 10-30% of the surface area of the anode protection layer. The percentage surface area of the domains may be less than or equal to the mass of the polymer as a percentage of the mass of the first and second polymers.

Optionally, the second polymer:first polymer weight ratio of the anode protection layer is in the range of 60:40-99:1, optionally 70:30-90:10.

Optionally, the anode protection layer has a thickness in the range of about 10 nm-5 microns, optionally about 10 nm-150 nm, optionally about 20 nm-120 nm.

First and second polymers may be selected according to their differences in properties which cause them to phase separate including, without limitation, differences in polarity; polarizability or dispersive forces (i.e. ease of inducing transient dipole moments), and ability to engage in hydrogen bonding.

The size of the domains may be controlled by, without limitation, the proportion of first and second polymers; the one or more solvents; the anode current collector surface, e.g. the anode current collector surface roughness, the film thickness and the rate of drying.

FIG. 3 illustrates an anode protection layer in which the matrix comprises or consists of a second polymer which is less ion permeable than the first polymer disposed in the domains and in which the matrix is less permeable than the domains.

In other embodiments, the domains comprise the second polymer, the matrix comprises the first polymer, and the matrix is more permeable to the electrolyte than the domains.

First Polymer

The first polymer may be amorphous.

The first polymer is preferably a non-conjugated polymer. The first polymer is preferably an electrically insulating polymer.

Exemplary first polymers include, without limitation, poly(ethylene oxide) (PEO) and polymethylmethacrylate (PMMA), polyethylenimine (PEI), polydimethylsiloxane (PDMS), polyvinylpyrrolidone (PVP), polyacrylamide (PAM) and polyacrylonitrile (PAN).

Second Polymer

The second polymer may be a semiconducting polymer, in which case it is preferably non-doped.

Preferably, the second polymer has an electrical conductivity of less than 1 S/cm, optionally in the range of 10⁻³-10⁻⁶ S/cm.

In some embodiments, the second polymer is at least partially crystalline.

In some embodiments, the second polymer is a conjugated polymer, i.e. a polymer having a backbone in which repeat units are directly conjugated to one another. The conjugated polymer may be conjugated along the entire length of its backbone or may contain conjugated regions interrupted by non-conjugated regions.

The second polymer may contain one or more arylene repeat units, optionally one or more repeat units selected from phenylene, fluorene, indenofluorene, naphthylene, anthracene, phenanthrene and dihydrophenanthrene repeat units, each of which may be unsubstituted or substituted with one or more substituents. The or each arylene repeat unit may be substituted with one or more substituents R¹ selected from:
linear, branched or cyclic C₁₋₂₀ alkyl wherein one or more non-adjacent, non-terminal C atoms may be replaced by O, S, NR², CO or COO wherein R² is a C₁₋₂₀ hydrocarbyl group and wherein one or more H atoms of the C₁₋₂₀ alkyl may be replaced with F;
a group of formula -(Ak)u-(Ar¹)v wherein Ak is a C₁₋₁₂ alkylene chain in which one or more C atoms may be replaced with O, S, CO or COO; u is 0 or 1; Ar¹ in each occurrence is independently an aromatic or heteroaromatic group which is unsubstituted or substituted with one or more substituents; and v is at least 1, optionally 1, 2 or 3; and
a crosslinkable group.

By “non-terminal” C atom of an alkyl group as used herein is meant a C atom of the alkyl other than the methyl C atom of a linear (n-alkyl) chain or the methyl C atoms of a branched alkyl chain.

Ar¹ is preferably phenyl.

Where present, substituents of Ar¹ may be a substituent R³ which in each occurrence is independently selected from C₁₋₂₀ alkyl wherein one or more non-adjacent, non-terminal C atoms may be replaced by O, S, NR², CO or COO and one or more H atoms of the C₁₋₂₀ alkyl may be replaced with F.

Crosslinkable groups include, without limitation, groups containing benzocyclobutene and groups containing a unit of formula —C(R⁴)═CH₂ wherein R⁴ is H or a substituent, optionally a C₁₋₁₂ alkyl.

The polymer may contain one or more heteroarylene repeat units, optionally one or more repeat units selected from thiophene, bithiophene, benzothiadiazole, pyridine, pyrimidine, pyrazine, triazole, imidazole, thiazole, quinoline, isoquinoline, indolizine, carbazole, acridine, and o-phenanthroline, each of which may be unsubstituted or substituted with one or more substituents R¹.

The polymer may contain one or more arylamine repeat units, optionally one or more triarylamine repeat units and/or 1,4-bis(diphenylamino)phenylene repeat units, each of which may be unsubstituted or substituted with one or more substituents R¹.

Preferably, the second polymer contains fluorene repeat units.

Exemplary second polymers or precursors thereof include F8BT and F8TFB:

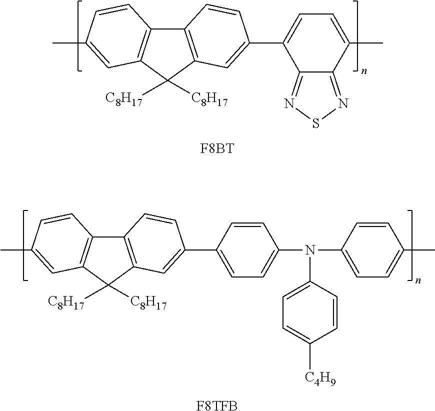

A precursor of the second polymer may be substituted with a crosslinkable group which is reacted following deposition of the second polymer precursor.

The polystyrene-equivalent number-average molecular weight (Mn) measured by gel permeation chromatography of the first or second polymer described herein may independently be in the range of about 1×10³ to 1×10⁸, and preferably 1×10⁴ to 5×10⁶. The polystyrene-equivalent weight-average molecular weight (Mw) of the first and second polymers described herein may independently be 1×10³ to 1×10⁸, and preferably 1×10⁴ to 1×10⁷.

Anode Protection Layer Formulations

In formation of the precursor of the anode protection layer prior to plasma treatment, the first polymer or a precursor thereof (e.g. a monomer or mixture of monomers for forming the first polymer) may be deposited onto a substrate from a formulation comprising the first polymer and any other materials of the anode protection layer dissolved or dispersed in one or more solvents.

Formation of the anode protection layer may comprise deposition of the formulation over the substrate, e.g. the anode current collector, followed by evaporation of the one or more solvents.

If the formulation contains first and second polymers then the formulation may phase separate into the matrix and domains.

According to some embodiments, the formulation contains a liquid electrolyte.

According to some embodiments, liquid electrolyte is applied to the surface of a film formed upon evaporation of the one or more solvents, either before or after plasma treatment.

The electrolyte may form a gel with the first polymer.

Formulations as described anywhere herein may be deposited by any suitable solution deposition technique including, without limitation, spin-coating, dip-coating, drop-casting, spray coating and blade coating.

Solvents may be selected according to their ability to dissolve or disperse the first polymer. Exemplary solvents include, without limitation, benzene substituted with one or more substituents, optionally one or more substituents selected from C₁₋₁₂ alkyl, C₁₋₁₂ alkoxy; ethers; esters; fluorinated solvents; and mixtures thereof.

Optionally, the formulation is heat and/or vacuum treated following deposition. Optionally, heating is at a temperature in the range of about 50-120° C., optionally 50-100° C.

Separator

The separator may be any suitable electrically insulating separator known to the skilled person.

The separator may be a porous separator. The porous separator material is optionally not ion conducting. In use, a liquid electrolyte may be absorbed by the porous separator material. The porous separator material preferably comprises or consists of one or more polymers e.g. polyethylene, polypropylene (e.g. blown microfibre polypropylene) and combinations thereof. The separator may contain a polymer bilayer or trilayer, for example polypropylene-polyethylene or polypropylene-polyethylene-polypropylene. The separator may comprise or consist of a composite material, e.g. a polymer and ceramic composite for example an aramid fibre/ceramic composite. The separator may comprise or consist of glass fibre.

The separator may be a solid state electrolyte e.g. a solid polymer electrolyte or solid metal oxide electrolyte. The separator may be a gel electrolyte. The electrolyte may be a composite polymer electrolyte comprising particles, e.g. ceramic particles, dispersed in a gel.

In the case where the separator is a solid state or gel electrolyte, the liquid electrolyte may not be required for ion transport between the cathode and the anode protection layer. According to these embodiments, in manufacture of the metal battery or metal battery precursor the anode protection layer may be formed with liquid electrolyte disposed in the anode protection layer.

Electrolyte

The electrolyte may be an organic solvent or a blend of organic solvents having metal ions dissolved therein. The solvent is optionally an alkyl carbonate or a mixture of organic carbonates, for example propylene carbonate, ethylene carbonate, dimethyl carbonate, ethylmethyl carbonate, fluoroethylene carbonate, vinylene carbonate, dimethoxyethane, diglyme, triglyme, tetraglyme, tetrahydrofuran, dioxolane, acetonitrile, adiponitrile, dimethylsulfoxide, dimethylformamide, nitromethane, N-methylpyrrolidone, ionic liquids, deep eutectic solvents and mixtures thereof.

A salt having a metal cation, may be dissolved in the electrolyte solvent, for example lithium bis(trifluoromethylsulfonyl)imide (LiTFSI) or lithium hexafluorophosphate Li bis(fluorosulfonyl)imide (LiFSI), LiAsF₆, LiSbF₆, LiClO₄, Li bisoxalatoborane, LiBF₄, LiNO₃, Li halides, Li dicyanamide and combinations thereof.

Cathode

The cathode may be any cathode known to the skilled person capable of releasing and reabsorbing metal ions for example, in the case of a lithium battery, LiCoO₂, LiNiₓMn_{y}Co_{z} (e.g. NMC 622 and 811), LiFePO₄, LiMnO₂, LiNiCoAlO₂, V₂O₅, sulfur, and (in the case of a lithium-air battery) oxygen.

Applications

The metal battery as described herein is preferably a lithium battery. The metal battery as described herein is preferably a secondary metal battery.

The metal battery as described herein may be used in a wide variety of applications including, without limitation, portable electronic devices such as phones, tablets and laptops; vehicles including cars, electric motorbikes, electric bicycles and drones; medical devices; wearable electronic devices; and energy storage for storage of energy from renewable energy sources such as solar, wind or hydroelectric power sources.

### Examples

Substrate Preparation

The surface of a 2 inch soda-lime glass substrate was etched with a 50 W high power IR CO₂ laser, followed by treatment with UV/Ozone for 120 seconds, to increase reactivity of the glass surface. The activated glass surface was rendered hydrophobic and oleophobic by treatment with perfluorooctyltricholosilane which was spin-coated onto the substrate from a solution in anhydrous ortho-xylene (6 drops per 5 mL).

The resulting perfluorinated silane surface layer was then locally ablated in a second laser etching step to create a wettable surface area in the centre of the glass substrate surrounded by the remaining perfluorinated silane layer for containment of a polymer solution deposited onto the substrate.

Polymer Swelling and Solubility

Polymer was dissolved by heating at 80° C. in toluene for approximately 30 minutes. In case of PMMA, a 5 wt % solution was made up, whereas for PEO a 2.5 wt % solution was made.

About 25 mg of polymer (dry weight) was cast onto the central, wettable surface area of the glass substrate followed by evaporation of the solvent in a glovebox and drying at 80° C. on a hotplate.

The substrate was weighed (first weighing) before casting of the polymer and after drying of the polymer film (second weighing) to determine the mass of polymer on the substrate.

The polymer film was subjected to a plasma treatment using a Corial Reactive Ion Etching plasma tool with the following settings:

Pressure 150 mTorr

Plasma treatment time 120 seconds

Power 300 W

Ar flow rate 200 sccm

He flow rate 8 sccm

CHF₃ flow rate 50 sccm* *where present; not all plasma treatments included CHF₃ sccm=Standard cubic centimetre per minute

The plasma-treated polymer film was soaked in 1 mL of propylene carbonate (Sigma-Aldrich, 99.7% anhydrous), for up to 17 hours.

Excess solvent was removed by a ‘dabbing’ method, whereby the wet, polymer-coated glass substrate was placed between two layers of highly absorbing clean-room type wipes (Berkshire Choice Supersorb CHSS09.14), and the excess solvent was removed by gentle pressing.

The substrate and film was then weighed (third weighing) to determine the mass of the polymer which had not dissolved in the solvent+mass of the solvent retained within the polymer as a result of polymer swelling.

Solvent in the swollen polymer was removed by heating the substrate at 110° C. for 2.5 hours in a glove box and the substrate and polymer film (fourth weighing) to determine an end mass of dry polymer.

Results are set out in Table 1

TABLE 1

| | | | Average |
|---|---|---|---|
| | | Average swelling | mass loss |
| Polymer | Plasma treatment | [mass %] | [mass %] |
| 350k Mw PMMA | None | Not applicable, | 100% |
| | | the polymer | |
| | | dissolved fully | |
| 350k Mw PMMA | He:Ar plasma only | +450% | 14% |
| 350k Mw PMMA | He:Ar | +380% | 2% |
| | plasma & CHF₃ | | |
| 100-200k Mw PEO | no plasma treatment | +270% | 23% |
| 100-200k Mw PEO | He:Ar | +190% | 5% |
| | plasma & CHF₃ | | |

As shown in Table 1, plasma treatment with a noble gas plasma significantly reduces solubility and swelling and these parameters may further be reduced by inclusion of CHF₃. Accordingly, solubility and swelling can be controlled without the need for chemical groups, e.g. crosslinking groups, either mixed with or bound to the polymer. The plasma treatment may be selected to independently control solubility and swelling according to the desired properties of the anode protection layer.

Without wishing to be bound by any theory, plasma treatment causes crosslinking of the polymer, thereby reducing its solubility and capacity for swelling.

Phase Separation Morphology

Plasma treatment as described herein may be carried out on a phase-separated layer formed from a mixture of polymers of differing ion permeability.

After spin coating on a given substrate from solution at a spin rate of 1000 rpm, phase separation morphology of polymer mixtures was investigated using optical and fluorescence microscopy as well as scanning electron microscopy (SEM) and atomic force microscopy (AFM).

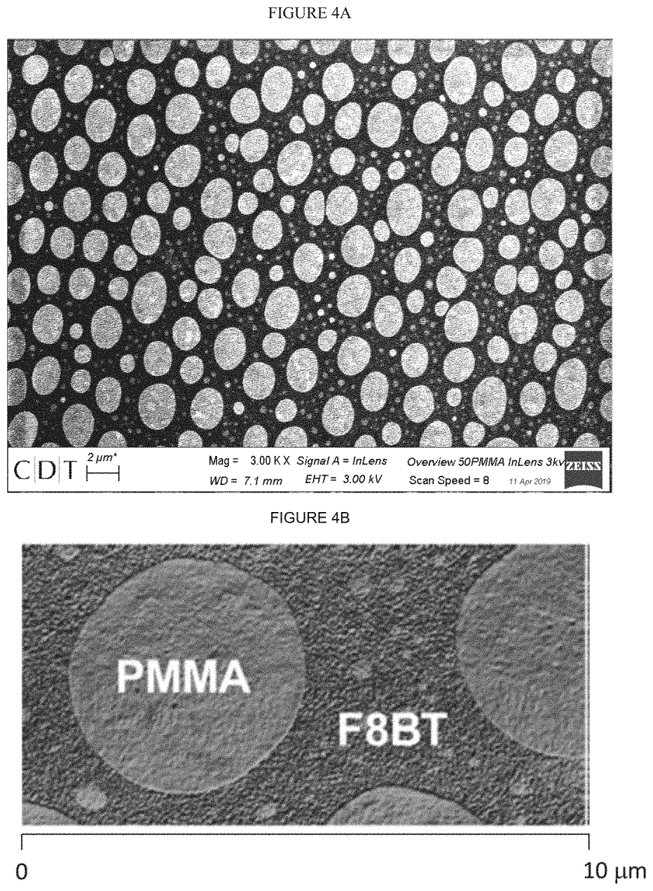

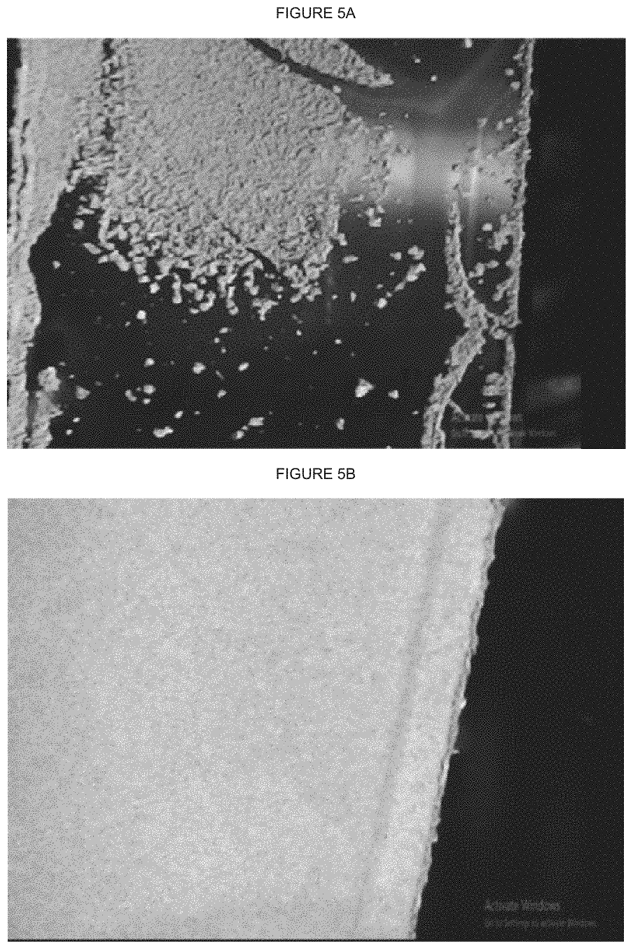

F8BT-PMMA 75:25 blends spin coated on glass from toluene at a spin rate of 1000 ppm, resulted in films with a thickness of ˜50 nm, exhibiting a phase separation morphology consisting of circular domains of PMMA (˜1-2 μm diameter) densely packed (˜2-4 μm apart) within a matrix of F8BT, as shown in the scanning electron microscopy (SEM) and atomic force microscopy (AFM) of FIGS. 4A and 4B, respectively.

The ˜50 nm thick F8BT-PMMA 75:25 blend films spin coated on Cu from toluene exhibit a phase separation morphology in which domains of F8BT and PMMA align in striations on the Cu foil surface, without the formation of isolated circular domains of PMMA.

F8BT-PEO 75:25 blends spin coated on glass from toluene, resulting in films with a thickness of ˜50 nm, exhibit a similar phase separation morphology consisting of circular domains of PEO (˜2-5 μm diameter) densely packed within a matrix of F8BT. When the same ratio of F8BT-PEO is spin coated from a toluene solution of twice the concentration, giving films with a thickness of ˜110 nm, the circular PEO domains are observed to form in roughly two size groupings: one with diameters of ˜1-2 μm and other with diameters of ˜5-10 μm. Further, F8BT-PEO 75:25 blends spin coated on glass from the higher boiling dichlorobenzene (DCB) solvent, resulting in films with a thickness of ˜40 nm, a phase separation morphology comprising sparsely packed circular domains of PEO (˜1-2 μm diameter) within a matrix of F8BT. PEO domains are also apparent below the F8BT surface but do not seem to extend through the F8BT surface.

The ˜50 nm thick F8BT-PEO 75:25 blend films spin coated on Cu foil from toluene exhibit a phase separation morphology in which isolated circular domains of PEO within a matrix of F8BT. In some regions on the Cu foil surface there is a higher density of Circular PEO domains lying in striations on the cu surface. However, ˜30 nm thick F8BT-PEO 75:25 blend films spin coated on Cu foil from toluene do not exhibit isolated circular domains of PEO but show a phase separation morphology in which domains of F8BT and PEO align in striations on the Cu foil surface, similar to that of F8BT-PMMA on Cu foil.

F8BT-PEO 90:10 blends spin coated on glass from toluene, resulting in films with a thickness of ˜60 nm, exhibit a similar phase separation structure to the 75:25 blend but with smaller (0.5-2 μm) PEO domains packed within the matrix of F8BT.

F8BT-PEO 25:75 blends spin coated on glass from toluene, resulting in films with a thickness of ˜80 nm, exhibit an ‘inverted’ phase separation morphology consisting of circular domains of F8BT (˜1-2 μm) within a matrix of PEO.

The phase separation results are summarised in Table 2.

TABLE 2

| | | | | Film | |
|---|---|---|---|---|---|
| Polymers in | Blend | | | thickness | |
| blend | ratio | Solvent | Substrate | [nm] | Morphology |
| F8BT-PMMA | 75:25 | Toluene | Glass | 50 | Circular domains of |
| | | | | | PMMA (~1-2 μm) in |
| | | | | | F8BT matrix. |
| F8BT-PMMA | 75:25 | Toluene | Cu foil | 50 | Domains of F8BT and |
| | | | | | PMMA aligning in |
| | | | | | striations on the Cu |
| | | | | | foil. No circular |
| | | | | | domains. |
| F8BT-PEO | 75:25 | Toluene | Glass | 50 | Circular domains of |
| | | | | | PEO (~2-5 μm) in |
| | | | | | F8BT matrix. |
| F8BT-PEO | 75:25 | Toluene | Glass | 110 | Circular PEO domains |
| | | | | | in two size groupings: |
| | | | | | one of ~1-2 μm |
| | | | | | diameters and one |
| | | | | | of ~5-10 μm diameters. |
| F8BT-PEO | 75:25 | DCB | Glass | 40 | Sparse distribution of |
| | | | | | circular PEO domains |
| | | | | | (~1-2 μm) in F8BT |
| | | | | | matrix with subsurface |
| | | | | | PEO domains visible. |
| F8BT-PEO | 75:25 | Toluene | Cu foil | 50 | Circular domains of |
| | | | | | PEO (~2-5 μm) in |
| | | | | | F8BT matrix. |
| F8BT-PEO | 75:25 | Toluene | Cu foil | 30 | Domains of F8BT |
| | | | | | and PMMA aligning in |
| | | | | | striations on the Cu |
| | | | | | foil. No circular |
| | | | | | domains. |
| F8BT-PEO | 90:10 | Toluene | Glass | 60 | Circular domains of |
| | | | | | PEO (~0.5-2 μm) in |
| | | | | | F8BT matrix. |
| F8BT-PEO | 25:75 | Toluene | Glass | 80 | Circular domains of |
| | | | | | F8BT (~1-2 μm) in |
| | | | | | PEO matrix. |

1. A method of forming a metal battery or an anode-free precursor thereof comprising:
an anode current collector;
a cathode;
a cathode current collector in electrical contact with the cathode; and
an anode protection structure comprising an anode protection layer disposed between the anode current collector and the cathode,
wherein the anode protection layer comprises a polymer and formation of the anode protection layer comprises plasma treatment of anode protection layer precursor comprising the polymer.

2. The method according to claim 1 wherein the method is a method of forming a metal battery; an anode is disposed between the anode current collector and the anode protection structure; the anode is in electrical contact with the anode current collector; and the anode is in direct contact with the anode protection structure.

3. The method according to claim 1 wherein the method is a method of forming a metal battery precursor and the anode protection structure is in direct contact with the anode current collector.

4. The method according to claim 1 wherein a separator is disposed between the anode protection structure and the cathode.

5. The method according claim 1 wherein the metal battery or anode-free precursor thereof further comprises a liquid electrolyte.

6. The method according to claim 1 wherein the plasma comprises an inert gas.

7. The method according to claim 6 wherein the plasma comprises at least one noble gas.

8. The method according to claim 7 wherein the plasma comprises at least one of He and Ar.

9. The method according to claim 6 wherein the plasma consists of one or more inert gases.

10. The method according to claim 6 wherein the plasma further comprises a hydrofluorocarbon.

11. The method according to claim 10 wherein the hydrofluorocarbon is CHF₃.

12. The method according to claim 1 wherein the polymer is selected from PEO and PMMA.

13. The method according to claim 1 wherein formation of the anode protection layer comprises formation and plasma treatment of the anode protection layer precursor on the anode current collector.

14. The method according to claim 1 wherein formation of the anode protection layer comprises formation and plasma treatment of the anode protection layer precursor on a substrate.

15. The method according to claim 14 wherein the anode protection layer is separated from the substrate and disposed over the anode current collector.

16. The method according to claim 1 wherein the metal battery is a lithium battery.

17. The method according to claim 1 wherein the anode protection structure consists of the anode protection layer.

18. The method according to claim 1 wherein the metal battery is rechargeable.

19. A metal battery or an anode-free precursor thereof comprising:
an anode current collector;
a cathode;
a cathode current collector in electrical contact with the cathode; and
an anode protection structure comprising an anode protection layer disposed between the anode current collector and the cathode,
wherein the anode protection layer comprises a plasma-treated polymer.
